(19) United States
(12) Patent Application Publication
(10) Pub. No.: US 2013/0124891 A1
(43) Pub. Date: May 16, 2013

(54) EFFICIENT CONTROL OF POWER CONSUMPTION IN PORTABLE SENSING DEVICES

(71) Applicant: Thomas Alan Donaldson, London (GB)

(72) Inventor: Thomas Alan Donaldson, London (GB)

(73) Assignee: AliphCom, San Francisco, CA (US)

(21) Appl. No.: 13/549,509

(22) Filed: Jul. 15, 2012

Related U.S. Application Data
(60) Provisional application No. 61/508,319, filed on Jul. 15, 2011.

(51) Int. Cl. G06F 1/32

(52) U.S. Cl. 713/322

(57) ABSTRACT

The various embodiments of the invention relate generally to portable devices and systems, including wearable devices, that include sensors that are used for sensing the physiological, emotional and/or environmental condition of a person carrying, wearing or otherwise using the device or system and more specifically, to an architecture and method reducing the power consumption of such devices and systems that include one or more sensors. In an embodiment, a wearable device includes one or more sensors, sensor data power optimization controller, a power-clock controller, a memory optimizer and a sensor optimizer.

### CROSS-REFERENCE TO RELATED APPLICATIONS

This nonprovisional patent application claims the benefit of U.S. Provisional Patent Application No. 61/508,319 filed on Jul. 15, 2011, which is incorporated herein for all purposes.

### FIELD

The various embodiments of the invention relate generally to portable devices and systems, including wearable devices, that include sensors that are used for sensing the physiological, emotional and/or environmental condition of a person carrying, wearing or otherwise using the device or system and more specifically, to a system, a device, an architecture and a method for reducing the power consumption of such devices and systems that include one or more sensors configured to sense condition of the person.

### BACKGROUND

Existing approaches to reduce sensor and/or sensor data processing power consumption are not well-suited to achieve sufficiently low power consumption for some uses. This is particularly the case for continuous or semi-continuous sensing systems, which typically are active and operate for a greater amount of time than do on-demand or sporadic sensing systems. For use cases or scenarios that depend on continuous or semi-continuous sensing, this can result in more expensive devices, larger devices, or devices that require recharging more often. One or more of these resulting characteristics can reduce how often a device is used and does impact the desirability of the device, and hence reduces the overall effectiveness of the device (such as by reducing the likelihood that a user will utilize the device as it is intended or as is needed to provide the desired benefits of the device). A further problem with such systems is that while individual elements perform adequately to reduce power consumption, the system components typically do not work well enough together to achieve optimal or closer to optimal operation in terms of reduced power consumption and overall efficiency for the entire system.

What is desired is a system, device, apparatus, and method for reducing the power consumption of a sensor and sensor data processing system, where one or more sensors, and in some cases, a sensor data power optimization controller are included in a portable device, including a wearable device. Embodiments of the invention address these problems and other problems individually and collectively.

### SUMMARY

In some embodiments, portable devices and systems include sensors, such as accelerometers, temperature sensors, infra-red sensors, etc., that are used for sensing the physiological, emotional and/or environmental conditions, such as heart-rate, blood oxygen perfusion, stress, arousal, warmth, etc., of a person carrying or otherwise using the device or system. In particular, the various embodiments relate to a sensor data power optimization controller that is configured to operate in cooperation with one or more such sensors to reduce power consumption of a wearable device.

A variety of techniques are available and can be employed by conventional on-demand or sporadic sensing devices and systems to reduce power consumption. For example, the sensor itself can include an interrupt mode, enabling the processing system to remain idle (and at a relatively lower-power consumption rate) until an event requiring sensing occurs. The sensor can include lower precision and lower sample rate modes, enabling lower-power operation. The sensor can include a buffer so that the sensing system need only communicate with the sensor after some number of samples are collected (rather than for every sample), and so can remain in a lower-power consumption mode for a longer period of time than would be practical without use of the buffer.

Sensor data processing systems that include a sensor data power optimization controller can include a relatively lower-power consumption mode in an effort to reduce power consumption. In some cases, this lower-power consumption mode can operate to modify an amount of circuitry, such as memory, that is retained in use to reduce power consumption.

### BRIEF DESCRIPTION OF THE DRAWINGS

FIG. 1 is a block diagram illustrating a sensor data power optimization controller implemented in a wearable device, according to some embodiments;

FIG. 2 is a block diagram illustrating components of a sensor data power optimization controller, according to an embodiment;

FIG. 3 is a block diagram illustrating a power-clock controller in accordance with some embodiments;

FIG. 4 is a graph illustrating operating characteristics of a multi-rate clock generator;

FIG. 5 is a diagram illustrating an example of a power-clock controller in accordance with some embodiments;

FIG. 6 is a block diagram illustrating a memory optimizer in accordance with some embodiments;

FIGS. 7A to 7C are flowcharts illustrating process of a memory optimizer in accordance with some embodiments;

FIG. 8 is a block diagram illustrating a sensor optimizer in accordance with some embodiments; and

FIG. 9 is a graph illustrating an example of a signal of various bandwidth derived from a sensor in accordance with some embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (hereafter “applications”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. The described techniques may be varied and are not limited to the embodiments, examples or descriptions provided.

Various embodiments are directed to systems, apparatus, devices, and methods for reducing power consumption in portable devices that include one or more sensors and can include the ability to process sensor data.

In some embodiments, a sensor data power optimization controller can be configured to reduce power consumption when used as part of continuous or semi-continuous sensing systems, in view of an on-demand or sporadic sensing system. For example, a heart-rate sensing system can be used in an on-demand mode, wherein the heart-rate is only measured (and hence the sensor system need only be active) for a short period of time (e.g. 1 minute) after a user requests a measurement of their heart-rate, for example by pressing a suitable button. By contrast, a heart-rate sensing system that continually measures the heart rate to produce a record or graph of minute-by-minute heart-rate over a period of several minutes, hours or even days cap be viewed as continuous or a semi-continuous sensing system. In an on-demand system, the sensor itself and the elements of the overall system concerned with data acquisition and data processing of the sensor output typically need only be active for relatively short periods (e.g. the 1 minute required to acquire the heart rate), whereas with a continuous or semi-continuous sensing system, at least some of these elements are required to be active and drawing more power for a relatively longer amount of time. Therefore, the overall contribution to system power consumption of the sensor and processing elements can be substantially different in the continuous or semi-continuous case that in the on-demand case, and hence different solutions can be used to optimize power consumption.

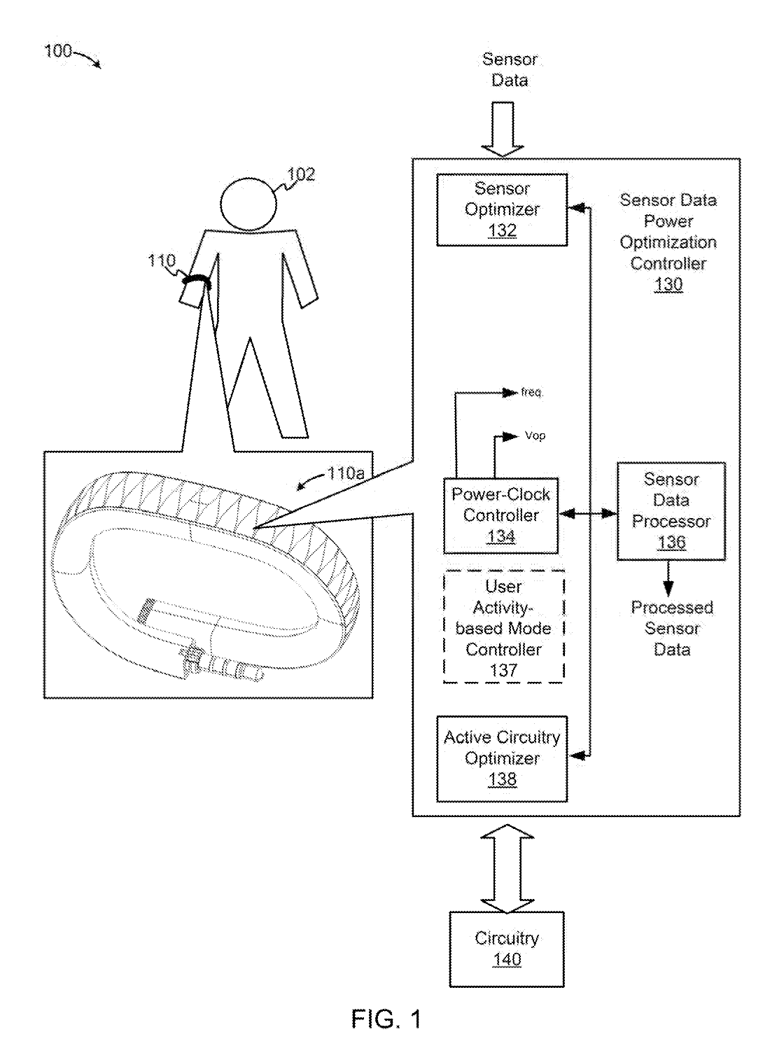

FIG. 1 is a block diagram illustrating a sensor data power optimization controller implemented in a wearable device, according to some embodiments. Diagram 100 depicts a user 102 wearing, carrying or otherwise being associated with a portable device 100 (e.g., a wearable device 110a). As shown, portable device 110 can include a sensor data power optimization controller 130 configured to optimize power efficiency of the wearable device operable, for example, with continuous and semi-continuous sensing systems. Such systems can be part of a device worn or carried by a person and be used to monitor one or more physiological or other characteristics of that person. As used herein, the term “portable device” or “portable sensor device” can be used interchangeably with “wearable device,” whereby such devices are not limited to being worn by a person or by being in direct contact with the person. Rather, the devices can be associated with one or more of physiological, emotional and/or environmental conditions of a person. As described herein, the techniques for reducing power consumption can be applied to any component of a portable sensing device or wearable device, including but not limited to a sensor data power optimization controller, one or more sensors, one or more memory banks or active circuits, any other component or sub-component thereof.

Power-clock controller 134 is configured to optimize power efficiency by, for example, by optimizing a clock frequency and operating voltage. In some embodiments, power-clock controller 134 is configured to select a clock frequency based on an amount of remaining processing cycles of a processor to achieve a target amount of processing cycles performed by a processor for a mode of operation. In some cases, power-clock controller 134 is configured to co-optimize power consumption and clock frequency for a wearable sensor device by, for example, pulse-width modulating the operation of two or more clocks, each clock frequency operating at a local optimum point in the power-consumption-per-cycle against frequency operating envelope for a sensor-related operation. Power-clock controller 134 also can select a minimum voltage for the clock frequency that is running at any point in time, whereby the minimum voltage and the clock frequency are selected to reduce power consumption.

In some embodiments, power-clock controller 134 can be configured to operate a processor in a switching mode of operation that includes operating the processor at a first voltage and at a first clock frequency during a first portion of the sensor-related operation, and operating the processor at a second voltage and at a second clock frequency during a second portion of the sensor-related operation. Operating the processor in the switching mode can include receiving data representing an amount of remaining processing cycles and an amount of time remaining for a timeframe in which the sensor-related operation is performed, and determining a next clock frequency, such as a minimum clock frequency, to establish an efficiency value. In some cases, power-clock controller 134 can be configured to update the clock frequency with the next clock frequency (e.g., another minimum clock frequency) that is optimize for another mode or another set of executed instructions during which another amount of power is drawn.

An active circuitry optimizer 138 is configured to manage operation of circuitry 140 so as to reduce power that can be attributed, for example, to active circuitry drawing power that can be controlled. In some embodiments, active circuitry optimizer 138 can allocate an amount of active circuitry in either a first portion of circuitry or a second portion of circuitry as a function of a measure of predicted usage of the data generated by the processor. If the predicted usage of one of the first portion or the second portion of the circuitry is greater than the other, then active circuitry optimizer 138 can be configured to select the portion of the circuitry that consumes the least power. In some cases, active circuitry can include memory. In some embodiments, active circuitry optimizer 138 is configured to allocate memory in accordance with a power-consumption strategy to thereby determine which memory elements are to be powered for a specified unit of data processing by a processor and/or other circuits, including sensors, to minimize power consumption. As such, active circuitry optimizer 138 can be configured to manage set of volatile and/or non-volatile memory elements (and data therein), which can be part of any of the components depicted in FIG. 1. In some embodiments, active circuitry optimizer 138 is configured to determine which of the powered-down memory elements (or groups of such elements) are to be activated to access memory elements, and to determine which memory elements (or groups of such elements) can be powered down from time to time to reduce power consumption. Active circuitry optimizer 138 can be configured to allocate and reallocate memory to different volatile and non-volatile memory banks (or other forms of groups or sets of memory elements) in a portable sensor device (e.g., a wearable device) according to a usage pattern (e.g., predicted usage pattern in the near future) so as to minimize the amount of memory that needs to be powered at a particular time.

According to some embodiments, active circuitry optimizer 138 is configured to allocate an amount of memory in either volatile memory or non-volatile of memory as a function of the measure of predicted usage. Further, active circuitry optimizer 138 is configured to determine a first amount of power to write data generated by a processor to non-volatile memory (“NVM”), determine an amount of time in which the processor is to rewrite the data, determine a second amount of power to store the data in volatile memory (“VM”) for the amount of time, and allocate the amount of memory based on the least power consumed of either the first or the second amounts of power. In some cases, the amount of active circuitry, including memory, further includes allocating, an amount of memory based on whether a reference object associated with the data generated by the processor is similar to other data stored in either volatile memory or non-volatile of memory, and storing the data in an allocated amount of memory in which the other data shares the same reference object. The reference object can include data specifying a relationship in which a certain sensor-related operation (and group of executable instructions) uses the data and the other data. According to some embodiments, memory or active circuitry can be allocated based on determining an amount of time in which data generated by a processor is to be stored, and storing the data either in a first memory bank if the amount of time is equivalent to a first time period (e.g., a shorter period of time) or in a second memory hank if the amount of time is equivalent to a second time period (e.g., a longer period of time). The second time period being greater than the first time period. Generally, active circuitry optimizer 138 is configured to store data that persist over longer periods of time in memory banks having smaller sizes (to reduce long-term power consumption), and store data that persist for shorter periods of time in memory banks having larger sizes.

A sensor optimizer 132 is configured to modify data collection characteristics to determine a subset of data collection characteristics with which sensor data is consumed by a processor to, for example, optimize an amount of sensor data that, is sufficient enough to be used by the processor per unit energy. In some embodiments, sensor optimizer 132 is configured to determine optimal values of one or more of a sampling rate, a bit-depth and a size of the buffer to provide an optimal value of power efficiency for the wearable device. That is, sensor optimizer 132 can be configured to modulate one or more of sensor latency, bit-depth and/or sample rate for a portable sensor/wearable device so as to maximize the information taken from the sensor per unit of enemy consumed by a wearable device and/or one or more of its components. In some embodiments, sensor optimizer 132 is configured to determining data representing an information metric, which can include data representing one or more of the following: a value of the sampling rate, a value of the bit-depth and a size of the buffer.

A sensor data processor 136 is configured to provide the logic to determine whether sensor data power optimization controller 130 ought control one or more of power-clock controller 134, sensor optimizer 132, and active circuitry optimizer 138 to reduce power consumption of one or more components of sensor data power optimization controller 130, or of any electronic component of wearable device 110a.

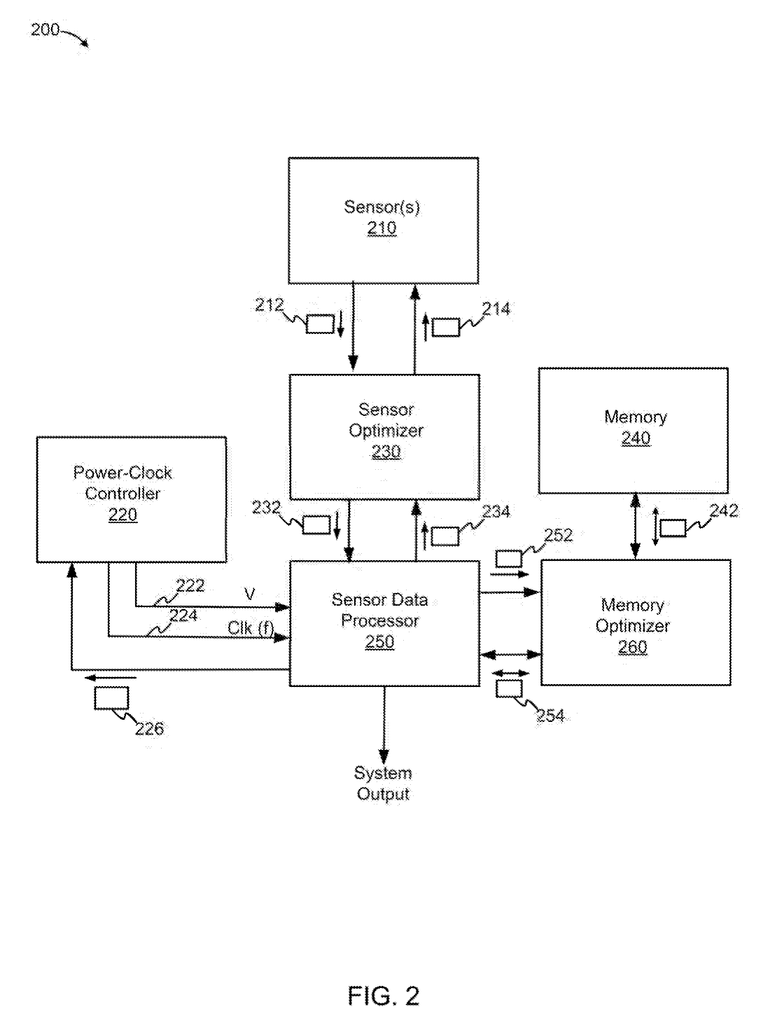

FIG. 2 is a block diagram illustrating components of a sensor data power optimization controller, according to an embodiment. A sensor data power optimization controller 200 can include one or more of the elements shown. As shown, a sensor data processor 250 can receive sensor data 232 (and sensor data 212) as an input, and can be configured to process this data to produce output data as a system output. Examples of output data include data representing physiological, emotional and/or environmental conditions of a person, including activity-related information about the activities in which the person is engaged. One or more sensors 210 are configured, to generate the sensor data 212, which can be equivalent to sensor data 232. For example, sensor data 232 can include sampled electro-cardiogram voltages, and the output data can represent a reading indicative of an average heart-rate in beats per minutes. Sensor data processor 250 can be a microprocessor, microcontroller, or digital signal processing system, together with associated memory, controllers, peripherals, busses, and the like, and can be implemented in hardware, software, or in combination of hardware and software. In some embodiments, sensor data processor 250 can operate to execute a set of instructions that are stored in a suitable memory element, such as memory 240, where execution of the instructions can result in implementation of a desired method or data processing operation.

A power-clock controller 220 can be configured to provide sensor data processor 250 with an operating voltage via path 222 and operating clock, signal via path 224 that are optimized to achieve low-power or reduced power consumption operation, as is described below. Power-clock controller 220 can be configured to optionally receive processing requirements information 226 from sensor data processor 250. Examples of processing requirements information 226 include operating mode, target processing in cycles per second, target latency, etc.

Memory optimizer 260 is configured to manage some or all of the memory elements of the portable device so as to minimize/optimize memory-related power consumption. Memory optimizer 260 is configured to receive memory reads and write requests 254 (and operations) as requested by sensor data processor 250 and translates these into reads and writes requests 242 for memory elements in memory 240. In addition, memory optimizer 260 can be configured to receive usage-related information 252 about the likely usage of the memory elements memory 240. Usage-related information 252 can be used to determine how to reduce the power consumption of the memory based on usage of the data.

A sensor optimizer 230 can be configured to manage one or more sensors 210 so as to reduce power consumption of the sensors. In some examples, sensor optimizer 230 can be configured to determine data collection characteristics 214, such as a value of a sampling rate at which sensor data is sampled, a value of the hit-depth of the sensor data, and a size of a buffer for collecting the sampled sensor data, any of which can be modified to reduce power consumption by the sensors and/or the wearable device.

Consider now a general case of power consumption of a sensor data power optimization controller, one or more sensors, and one or more memory banks or active circuits over multiple operating modes, where the energy consumed includes static and dynamic power consumption. The energy can be estimated as:

$$E = {\sum }_{mode = i} [ {V}_{i}^{3} {k}_{static} {N}_{i} + {V}_{i}^{2} {k}_{dynamic} {M}_{i} {f}_{i} ] {T}_{i}$$

where Vᵢ is the operating voltage used for the mode, Nᵢ is the number of transistors powered during, the mode, Mᵢ is the number of transistors powered and clocked during “mode (i),” fᵢ is the operating frequency for the mode, and Tᵢ is the time for which the mode is active. The variable k_{static} is a manufacturing process-derived constant determining the static power consumption (i.e., leakage) per powered transistor, and the variable k_{dynamic} is a manufacturing process-derived constant determining the dynamic power consumption per powered transistor per clock Hz.

The number of processing cycles performed can be determined by:

$$C = {\sum }_{mode = i} {f}_{i} {T}_{i}^{′}$$

where Tᵢ′≦Tᵢ is the time in which the mode is performing active processing rather than, for example, waiting for a clock to stabilize, waiting for the system voltage to reach an acceptable level, etc.

Therefore a measure of efficiency, η, is the energy consumed per unit of processing and can be determined by the following:

$$η = \frac{{\sum }_{mode = i} [ {V}_{i}^{3} {k}_{static} {N}_{i} + {V}_{i}^{2} {k}_{dynamic} {M}_{i} {f}_{i} ] {T}_{i}}{{\sum }_{mode = i} {f}_{i} {T}_{i}^{′}}$$

As is shown, minimizing the voltage while maximizing the frequency can result, at least in some cases, in increasing the efficiency, particularly in leakage-limited situations (e.g., during sensor-processing in portable platforms). However, note that the maximum achievable frequency can be a function of the voltage, at least within the operating envelope of typical data processing elements/means used for sensor systems. Thus, assuming the use of the maximum operating frequency possible for a given voltage, the efficiency measure can be written as

$$\frac{{\sum }_{mode = i} [ {V}_{i}^{3} {k}_{static} {N}_{i} + {V}_{i}^{2} {k}_{dynamic} {M}_{i} {F}_{max} ( {V}_{i} ) ] {T}_{i}}{{\sum }_{mode = i} {F}_{max} ( {V}_{i} ) {T}_{i}^{′}}$$

From the expression, the function, Fₘₐₓ(Vᵢ), can influence system efficiency, and, thus, can influence the energy consumed by a wearable device. In regions of operation where the gradient of this function is small (e.g., the gradient behavior in which rates of change, in frequency are small relative to voltage), increasing the operating frequency and decreasing the time for a given mode can improve efficiency. In some embodiments, relatively small gradients of the function can occur in data processing elements, such as a sensor data processor, at higher voltages and frequencies (that is, the function asymptotes to a constant voltage for operating frequencies above a certain level). Note that in some cases, “burst-mode processing” can be used for sensors, whereby burst-mode processing can include two portions: (1.) a first portion of burst-mode transfers data at a high frequency over a short duration to complete the processing, and (2.) a second portion of the burst mode at a low frequency over a long duration mode, which may likely perform little or no useful processing. By contrast, consider circumstances when the gradient or rate of change of the function is larger (that is, increases in voltage, (Vᵢ), are necessary to achieve increases in operating frequency, Fₘₐₓ), operating continuously at the lowest frequency to achieve the required processing is optimal in terms of efficient power consumption, at least in some examples. This gradient behavior can occur at lower operating frequency and voltages. Thus, continuous processing can be used in such circumstances (i.e. when there is relatively low amounts of processing): According to some embodiments, data processing can be performed by operating in accordance with frequency and voltage characteristics similar to or adapted from, either “burst-mode processing” or “continuous processing.” in combination or separately, to enhance efficiency.

Consider operation of one example of a sensor data power optimization controller, which may or may not include one or more sensors and one or more memory banks. In this example, the sensor data power optimization controller can operate with the following characteristics: operating voltage of 0.8 V up to 80 MHz and of 1.2 V up to 80-120 MHz. To illustrate, energy consumption behavior of the sensor data power optimization controller (e.g., including one or more sensors and/or memory) can be classified into three regions: a static limited region of operation (disregarding the dynamic part, thereby assuming zero dynamic power consumption), a dynamic limited region of operation (disregarding the static part, thereby assuming Zero static power consumption) and a balanced region of operation (where it is assumed k_{static}Nᵢ=k_{dynamic}Mᵢ, thereby assuming equivalent static and dynamic power consumption).

Consider next a requirement, for 100 MCycles processing in one second, and also consider three operating modes: (1.) continuous mode, (2.) burst-mode, and (3.) a “switching mode” whereby the system operates at 80 Mhz for 0.5 sec and then at 120 MHz for 0.5 sec.

| | Static | Dynamic | |
|---|---|---|---|
| Mode | Limited | Limited | Balanced |
| Continuous 100 MHz for 1 sec @ 1.2 V | 1.728 | 1.44 | 1.584 |
| Burst 120 MHz for 0.833 sec @ 1.2 V; | 1.44 | 1.44 | 1.44 |
| and 0 Hz@0 V otherwise | | | |
| 80 MHz for 0.5 sec @ 0.8 V; and | 1.12 | 1.12 | 1.12 |
| 120 MHz for 0.5 sec @ 1.2 V | | | |

As shown in the power consumption-related data in the table, the switching mode can be substantially more efficient (e.g., draws less power) than either continuous mode or burst mode (as much as 35% more efficient in the static limited case). Such efficiencies can be maintained over a substantial period (e.g. 10 ms) to achieve a processing rate switch. According to other embodiments, other factors can be controlled by a sensor data power optimization controller of FIG. 1 to control the overall system power consumption as it relates to operating frequency. For example, in particular, a power optimization controller can be configured to control the power consumption of a clock generation circuit (including the components of power-clock controller 220), and an efficiency of one or more power supplies configured to generate the voltage and power.

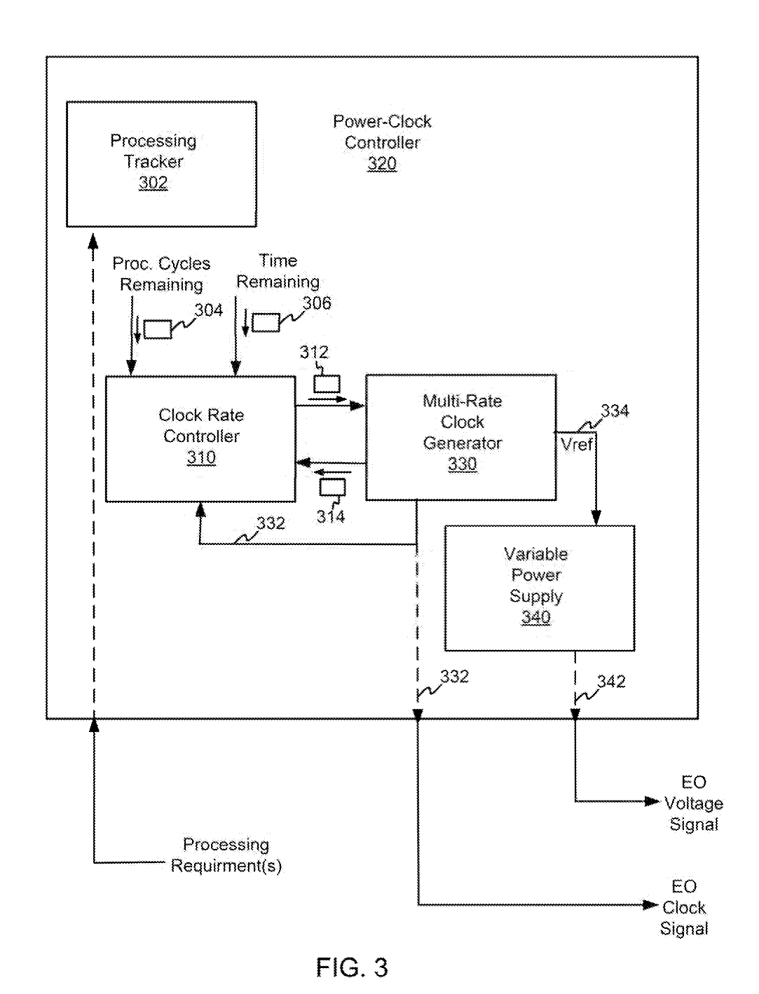

FIG. 3 is a block diagram illustrating a power-clock controller in accordance with some embodiments. A power-clock controller 320 can include a clock rate controller 310, a multi-rate clock generator 330, a variable power supply 340 (e.g., as a variable voltage supply) and an (optional) processing tracker 302. Clock rate controller 310 can be configured to receive a number of processing cycles remaining 304 in a sensor-related operation (e.g., an estimated number of processing cycles remaining to be processed within a given timeframe), and a timeframe 306 (e.g., time remaining) within which they should be processed. In some embodiments, data representing the number of processing cycles remaining 304 and time remaining 306 can be provided by processing tracker 302. For example, for a sensor data power optimization controller that can drive sensors with a sensor sampling rate of 100 Hz and an average of 100kCyles per sample, a clock rate controller 310 can be initialized at each sample with a number of processing cycles remaining being 100,000 and the timeframe being 10 ms.

Clock rate controller 310 can be configured to operate as a scheduler to provide a minimum clock frequency to multi-rate clock generator 330. The minimum clock frequency is a frequency in which a targeted amount of processing can be accomplished within a certain timeframe. In some embodiments, clock rate controller 310 can be configured to determine the minimum clock frequency by calculating the remaining cycles divided by the remaining time. In some cases, clock rate controller 310 can be configured to receive a clock signal 332 generated by multi-rate clock, generator 330, and data representing an actual clock frequency 314 generated by multi-rate clock generator 330. In some cases, clock signal 332 is a variable clock signal generated by a voltage-controlled oscillator, and actual clock, frequency 314 is a clock, frequency signal selected from a subset of finite values of clock frequency 314.

As the overall device and sensor system operates (e.g., the wearable device including its circuitry, sensors, processors, memory and sensor data power optimization controller), clock rate controller 310 can be configured to determine an updated estimate of the minimum required frequency, and maintain that updated clock frequency. For example, the updated clock frequency can be determined by an elapsed amount of time and an actual number of processing cycles completed at the actual clock rate (for the clock signal generated by multi-rate clock generator 330). In some cases, clock rate controller 310 can update the clock frequency from time to time, and the update period can be relatively long compared to the time taken by multi-rate clock generator 330 to switch its clock frequencies. The update period can be also relatively short compared to the likely processing timeframe. For example, if it takes an average 100 is to switch clock rates, then a 1 ms update period can be obtained for sensor data sampled at 100 Hz. It should be noted that too short an update period will increase the power wasted while waiting for the clock to switch, while too long an update period will reduce the certainty that the processing is completed in time.

In operation, multi-rate clock generator 330 generates an output clock that is configured to be no slower than a minimum clock frequency as specified at any point in time by clock rate controller 310. Multi-rate clock generator 330 can be configured to also indicate an actual clock rate that it is running (for example through a register). Multi-rate clock generator 330 also provides a voltage reference (“Vref”) via path 334 to a variable power supply 340, which provides system power at an efficient operating (“EO”) voltage in accordance with the voltage reference provided by multi-rate clock generator 330. The system voltage level can be proportional to the voltage reference and can be selected to operate at the minimum clock frequency that provides reduced power consumption.

Optional processing tracker 302 can generate data 304 representing an estimate of a number of processing cycles remaining and data 306 representing a timeframe within which to process the remaining processing cycles, based on monitoring the execution of code or another form of processor instruction or control. Processing tracker 302 can takes as its input information regarding, the current processing status and/or requirements, and can produce as its output an estimate of the number of processing cycles remaining 304 (and an indication of the time 306 in which those cycles should be completed). Processing tracker 302 can, for example, be implemented as hardware and/or a portion of software code that provides API calls allowing executing code or instructions to indicate when certain milestones are reached (e.g., a milestone can represent an indication of an amount of processing required), or processing, tracker 302 can operate to monitor a thread that (continuously or from time to time) and the size of a call stack or the number and type of threads, processes or code units that are suspended or operating, etc.

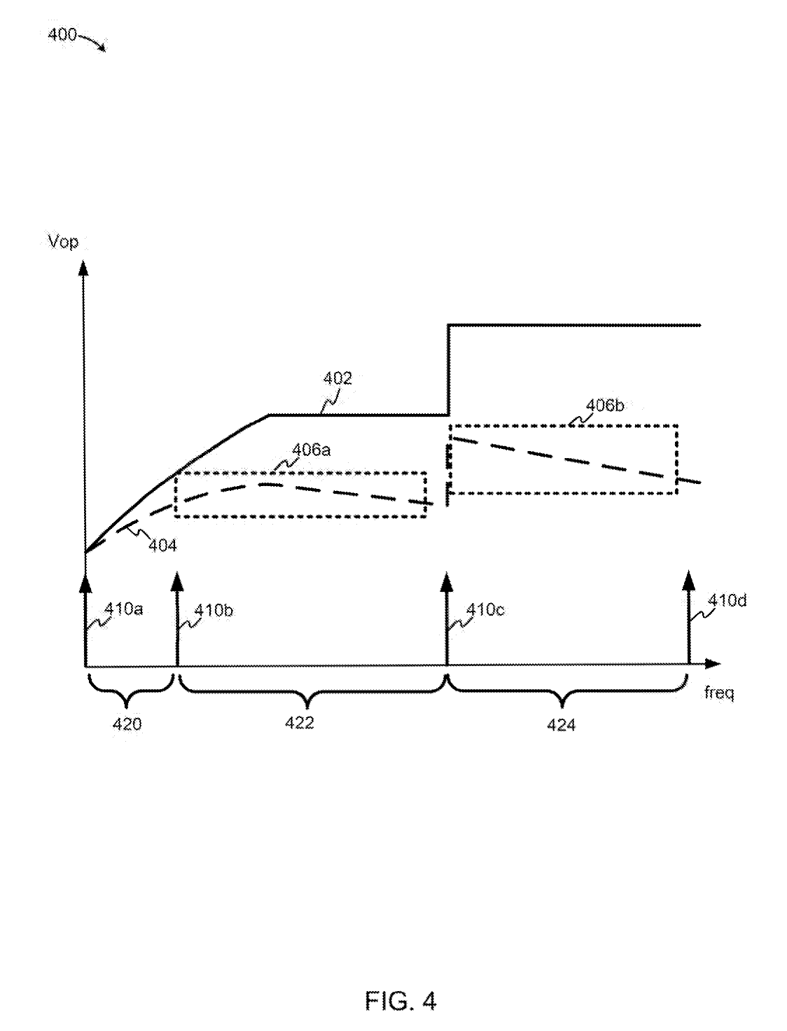

FIG. 4 is a graph illustrating operating characteristics of a multi-rate clock generator, according to some embodiments. Diagram 400 depicts a solid line representing a voltage-frequency relationship 403 for an example processor (or data processing system, such as sensor data power optimization controller and/or sensors and/or memory). Relationship 403 can be derived, for example, from manufacturer data sheets, or by profiling or characterizing operation of the processor by, for example, executing code at different voltage and frequency combinations. The dotted line indicates an amount of power consumption 404, which can be normalized by, for example, dividing power amounts by clock rate. Further, amounts of power consumption 404 also correspond to the power consumption per unit of processing work. Note that in some regions, such as region 420, an efficient operating frequency can be greater or equal to the operating frequency itself. However, in other regions, such as regions 422 and 424, the most efficient operating frequency can be substantially higher.

Therefore, for a processor and related circuitry (e.g., sensors) to operate efficiently, an actual operating clock frequency can reduced to a small range of frequencies, including individual clock frequency values 410a, 410b, 410c, and 410d. Further, the power-clock controller can prohibit usage of clock frequency ranges 406a and 406n. Thus, in some embodiments, the operation of a multi-rate clock generator can be summarized as providing a clock signal or signals at rates that represent efficient operating points or regions, and the multi-rate clock generator can generate a clock at a frequency greater than or equal to the specified minimum clock rate. The minimum clock rate can be at an efficient operating point, such as indicated by clock frequency values 410a, 410b, 410c, and 410d, or in an efficient region (as well as a voltage reference at the minimum voltage allowable for successful operation at the selected clock frequency).

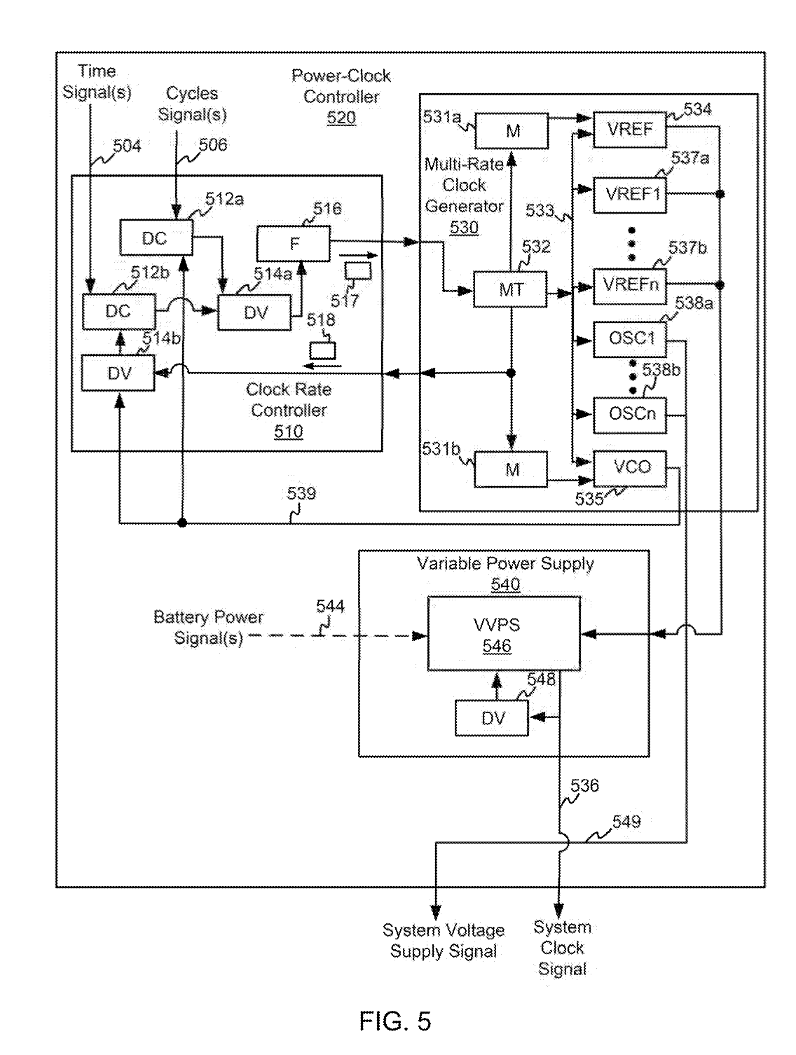

FIG. 5 is a diagram illustrating an example of a power-clock controller in accordance with some embodiments. As shown, power-clock controller 520 includes a clock rate controller 510, a multi-rate clock controller 530, and a variable power supply 540. Power-clock controller 520 includes down-counters (“DC”) 512a and 512b, divider circuits (“DV”) 514a and 514b, and a filter (“F”) 516. Power-clock controller 520 receives cycle data signal 506 representing the processing cycles remaining and time data signal 504 representing the time remaining, each data signal being fed into one of down-counters 512 (or a circuit having similar functions). After down-counter 512a, the cycle data signal 506 is driven by the actual output system clock 539. Down-counter 512b receives time data signal 504 and is driven by the actual system clock 539 divided by a value in a register associated with divider 514b that is set to a value associated with data 518 representing the actual frequency used. The value of the cycles remaining is divided at divider 514a by a value of the time remaining to generate data 517 representing a minimum processing cycle rate (i.e., the minimum frequency for the clock signal of the processor). Optionally, this value can be filtered at filter 516. An example of filter 516 is an overhang filter (i.e., where a given value cannot reduce before a minimum time).

Multi-rate clock controller 530 is configured to receive the minimum frequency signal 517 and to apply the minimum frequency signal 517 to a multi-threshold element (“MT”) 532. An example of multi-threshold element 532 includes a collection of comparators with different thresholds, with each threshold value driving an enable signal of a group 533 of enable signals. The enable signals enable operation of a certain oscillator and a voltage reference. Note that in one configuration, one frequency and one voltage can be enabled at a time. For example, one enable signal can enable a first voltage reference (“Vref1”) 537a and a first oscillator (“OSC1”) 538a, and another enable signal can enable another voltage reference (“Vrefn”) 5376 and another oscillator (“OSCn.”) 538b. These oscillators are used to generate a system clock signal on path 549. In some embodiments, a frequency and/or a voltage can be configured to vary with a frequency used (rather than fixed voltages and frequencies generated by voltage references 537a and 537b and oscillators 538a and 538b). As such, multi-rate clock controller 530 can generate a variable frequency using voltage-controlled oscillator (“VCO”) 535 and can generate a variable voltage using a variable voltage reference (“VREF”) 534. Multipliers 531a and 531a can be used to provide suitable control signals to variable voltage reference 534 and voltage-controlled oscillator 535, respectively. An example of a variable voltage reference 534 can be analog-to-digital convertor.

A selected voltage reference, Vref, can be used to provide the reference voltage for a voltage power supply 540 (e.g. as a switch-mode power supply). In some cases, voltage power supply 540 receives power from a battery via path 544 and includes a variable voltage power supply (“VVPS”) 546 and a divider 548 (e.g. a resistive divider), which is optionally used to feedback the system voltage on path 536 so that voltages greater than the current system voltage can be specified.

Next, in view of the efficiency equation discussed above, consider that the power consumption of a processing element or other elements of a device (or the device itself) can be proportional to a number of active (i.e., powered and/or clocked) transistors, other things being equal, and thus to a number of active, circuits. Note that one of the largest contributors to the number of active transistors is a memory or similar data storage element using various memory technologies, such as SRAM, Flash, etc.

In some existing sensor data processing systems, low-power modes are used, and these low-power modes often operate to reduce the amount of memory available or the rate at which memory can be accessed. However, for continuous sensing systems, such restrictions may not be appropriate. For example, in a sensing system where filters (e.g., FIR filters) are operating on data as part of the processing, the historical data (i.e., the filter delay line) is retained between samples. If the amount of data that must be retained exceeds the amount of storage available in a low-power mode, then either (1.) data is lost (which is typically unacceptable), (2.) the low-power mode cannot be used (leading to significantly increased power consumption), or (3.) the data is backed-up to non-volatile storage prior to entry into the low-power mode (which can significantly increase power consumption as well). Further, a data processing system can be configured to assume that memory needs to be available while operating in run mode. Even if not used for processing purposes, this memory likely consumes power, and therefore represents wasted power.

Consider further an operating mode for a sensor-driven system or processor that accesses memory associated with its operation. Typically, some unit of code (or set of executable instructions) can becomes active during the operation to perform some processing, and then the unit of code becomes inactive for a period of time. For example, a data processing thread can resume on each new sample, process the sample, and then be suspended until a new sample is available. A code unit that is inactive (e.g., a suspended thread) likely does not access memory allocated to it until it becomes active again (i.e., the thread resumes), although some memory can need to be retained while the code block is inactive. Furthermore, some of the data that is stored for the code unit may be relevant from when the code unit becomes active until the next point at which it becomes inactive. For example, a “scratch” working memory can be retained for each sample or frame processing cycle as it is typically involved in calculating the response to the new sample(s). Furthermore, some memory is not accessed every time a code unit becomes active, and can be accessed much more rarely. For example, some threads will accumulate samples into a buffer and, for instance, resumes long enough to copy the input data into a sample buffer. Then, the threads process the data in bulk once enough data has accumulated, or if certain calculations on the data indicate that more advanced processing is required. The memory allocated to assist with the advanced processing need not be required until the advanced processing operations are performed. Furthermore, some data will only be written rarely (for example, thread data structures) while other data will be written more often (for example delay lines).

Consider also the access of code or instructions itself (i.e., program memory) in this example. Typically, only a subset of the code is accessed in each resume/suspend cycle, and a smaller subset can be accessed when the data indicates that additional processing is required, or when the amount of data reaches a sufficient threshold, for example. Consider also a typical memory system associated with a portable data processor used to process data from sensors. For the sake of example, consider a system provided, with SRAM, for volatile storage, and FLASH memory for non-volatile storage and code. Caches can also be implemented.

In general, SRAM memory has a power consumption that is approximately proportional to the number of memory cells that are powered, where the memory are powered to retain data. However, memory cells typically come in large blocks (e.g. 256 KB). All the cells of such a block are powered to retain data in any one cell, and hence the power consumption is driven by the block size. Typically, the retention of 4 KB of data can require a power consumption of 10 μW, though this can vary from device to device.

FLASH memory works similarly, though a portion of the power consumption can be proportional to the operating clock frequency. Typically, data can be retained when the device is unpowered, but writing data during a write operation can incur a power consumption penalty. For example, a typical flash device can consume 10 mW when writing and can require 1 ms to write 256 bytes. Consider a 4 KB data block used as part of a data processing algorithm that operates on sensor data at 100 Hz. Assume that a data, processing algorithm accumulates 10 samples before processing the data in a manner that accesses the data in this block, with the data being retained in this block from one access to the next. If this data were retained in SRAM, the energy consumed in retaining the data between each access would be 1 μJ (10 μW for 100 ms). If written to flash, the energy consumed would be 160 μJ (10 mW for 16 ms). Now assume 256 bytes of data to be stored, but a minimum 64 KB SRAM block available in which to store it (which is quite typical of existing data processing means in nm-mode). In this case the data could written to FLASH for 10 μJ or stored in SRAM for 16 μJ. Thus, a memory block size, such as the SRAM block size and a FLASH block size, and the efficiency of the storage of data in SRAM (in particular, the size of an SRAM block that must be retained in order to store a particular piece of data) can be factors in determining the lowest power operation.

Now consider when a code unit or set of instructions becomes inactive (for example a thread gels suspended). At this point, memory accesses to blocks allocated to the code unit may no longer be required. Consider three types of memory: (1.) memory in which data need not be retained through to the resumption of activity; (2.) memory in which data needs be retained through to resumption and is likely to be re-written soon (i.e., soon enough that the power consumption “cost” of writing the data to non-volatile-storage is likely to be greater than the cost of volatile storage); and (3.) memory that needs be retained through to resumption of activity but is unlikely to be rewritten soon.

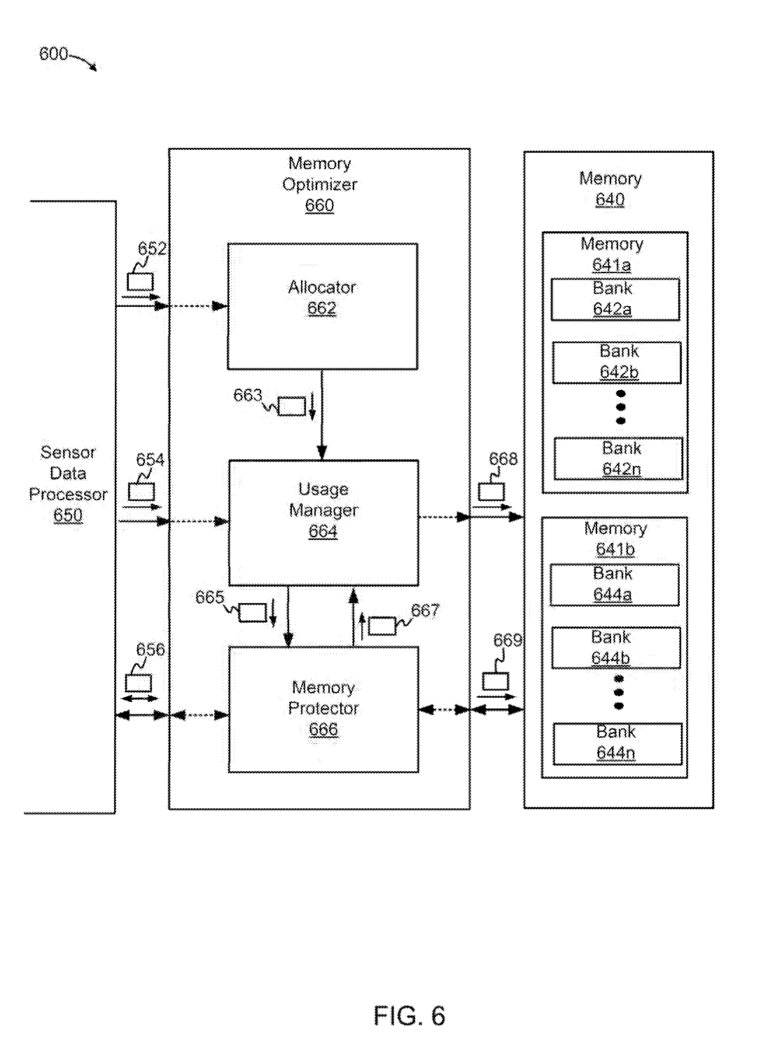

FIG. 6 is a block diagram illustrating a memory optimizer in accordance with some embodiments. As shown in diagram 600, at least in some embodiments, memory optimizer 660 includes an allocator 662 (e.g., a persistence-based allocator), a memory usage manager 664, and a memory protector 666. As shown, memory optimizer 660 is coupled between a sensor data processor 650 and a memory 640, which can include a first type of memory 641a and a second type of memory 641b. In some embodiments, the first type of memory 641a is volatile memory having a number of memory banks 642a, 642b and 642n, with each bank able to be independently powered-up or down. Memory banks 642a, 642b, and 642n are configured to retain data without enabling access, or to retain data and enable access with a voltage supply that optimizes power consumption in each mode (e.g., typically a lower voltage is required for storage-without-access than with access). Optimally, the initial banks 642a, 642h are smaller and increase to larger banks, such as memory bank 642n. The second type of memory 641b can include non-volatile memory having memory banks 644a, 644b, and 644n Which can be independently powered.

Allocator 662 is configured to receive requests 652 from sensor data processor 650 to allocate memory to various processes, code blocks and the like. These requests provide not just an amount of memory to be allocated (with possible alignment data), but also can include data representing one or more of (1) a measure of the likely persistence of the data before the next write of the data (i.e., “value-persistence”), (2) a measure of the likely persistence of the data before it is no longer read, again (i.e., “reference-persistence”), and (3) a reference object whose, activity, validity or presence can be used to infer whether or not data currently stored for a memory block is still required at any point in time (as opposed to whether the memory block itself is still required).

In some embodiments, allocator 662 manages both volatile and non-volatile writeable storage, such as FLASH, in a single interface. Allocator 662 functions to allocate memory requests to non-volatile memory where, on the basis of the value-persistence measure, the write energy consumption would be less than the energy consumption of storing it in volatile storage. In addition to minimizing the number and size of memory banks used (and hence the power consumption of those banks), allocator 662 also allocates memory requests 663 of differing reference-persistence measure and reference object state to different banks of volatile memory in order to minimize the average power consumption.

An example strategy is to do as follows: (1.) allocate the longer reference-persistence blocks to the smaller memory hanks (provided such banks are larger than the memory block requiring allocation), (2.) group memory requests sharing a reference-object in the same memory bank(s), and (3.) group memory requests of similar reference-persistence together. This strategy can increase the likelihood that blocks of memory can be turned off for extended periods of time.

Usage manager 664 is configured to receive data 654 (in the form of instructions, commands, etc.) from sensor processor 650 to update the memory allocated, for example to allocate new memory or free existing memory. Usage manager 664 acts to enable those memory banks that require access, such as during a first access and not on allocation, via memory protector 666. In addition, usage manager 664 can operate to disable memory banks using disable instruction data 668, which disable memory banks that are not currently storing meaningful data (for example when an update from the sensor processing unit indicates that the last allocated block in a given memory bank should be freed). Usage manager 664 can also receive a signal 654 from sensor data processor 650 and/or allocator 662 indicating that a reference-object for some allocations has changed state, and that memory usage dependent on the reference-object can be freed.

Memory protector 666 acts to ensure that memory accesses (i.e., read/writes) are to memory addresses that are valid and to memory banks that are currently enabled. It receives as its input the address 656 of a read/write operation, which is compared to the currently enabled/valid memory addresses. It the read/or write operation is to a currently valid/enabled memory address, then the read/write signal 669 is transmitted to perform an access of the memory. If the memory address is not enabled and/or valid, then memory protector 666 prevents the read/write being performed immediately and provides a signal 667 to usage manager 664 to indicate the memory address (and hence memory bank) to which access is required (enabling the memory bank usage manager to enable this bank). Memory protector 666 can also receive as an input signals 665 indicating the currently enabled memory banks.

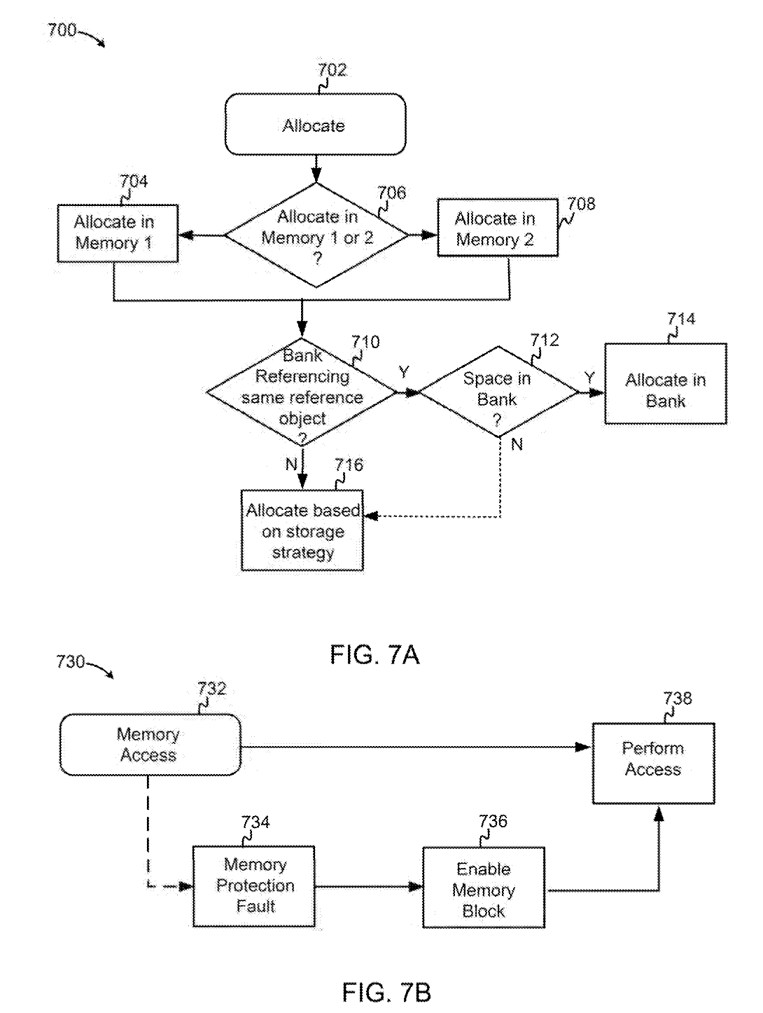

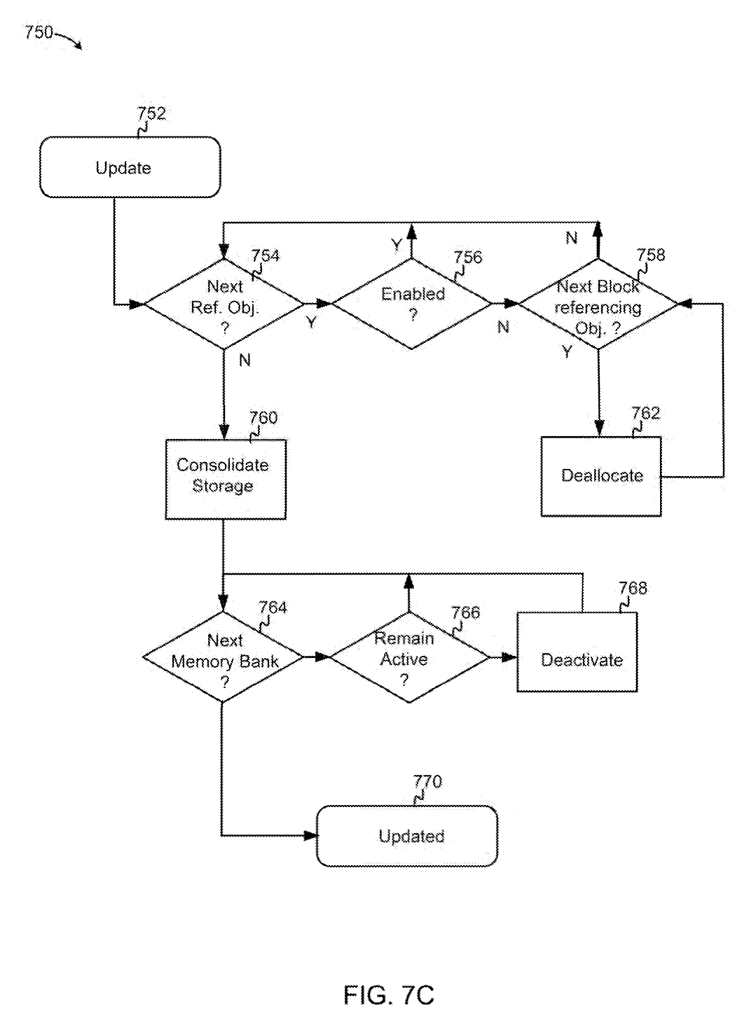

FIGS. 7A to 7C are flowcharts illustrating process of a memory optimizer in accordance with some embodiments. Specifically, FIG. 7A illustrates the activity of an example of an allocator, FIG. 7B illustrates the activity of a memory protector When a disabled bank is accessed, and FIG. 7C illustrates the activity of a usage manger when an update is required.

As shown in FIG. 7A, flow 700 begins at 702, at which an allocator initiates an allocate process. At 706, a determination is made as to whether volatile or non-volatile memory storage for a memory block (i.e., a set of data) would lead to lower power consumption (e.g., by determining the likely power consumption until the value is rewritten). Either volatile memory is selected at 704 or non-volatile memory is selected at 706. The allocator determines at 710 whether bank shares a reference object. If yes, then flow 700 determines that there is space in the bank and allocates the data in the same bank as other memory referencing the same reference object (since they are likely to be enabled/disabled at the same time). If the bank does not share a reference object with other data, then allocator memory according to a strategy at 716 that tries to place the longest stored reference-persistent objects in the smallest memory banks (because these banks will be active longest, and smaller memory banks consume less power because of the fewer transistors/memory elements). In some embodiments, a reference object includes data specifying a relationship in which the sensor-related operation uses the data and the other data and relates to the allocation of memory to store the data and other data.

FIG. 7B illustrates a flow 730 describing the activity of a memory protector when a disabled bank is accessed. For example, a memory protector process can monitors memory requests at 732 (e.g., data read or data write commands) from the sensor data processor to determine whether or not each such access request is to memory that is or is not enabled. It functions to enable needed memory and to delay execution of processing dependent on data access to non-enabled memory until that memory is enabled. The memory protector can, for example, be implemented via a memory protection unit that operates by monitoring the addresses on the memory bus, and if an invalid/disabled memory address is provided, flow 730 can generate a hardware interrupt, which often is known as an exception or fault, at 743. In such an instance, the memory protector can additionally require software code running on the sensor data processor to handle the interrupt and pass suitable signals to a usage manager. Then, the memory block can be enabled at 736 to perform a memory access at 738.

FIG. 7C illustrates a flow 750 describing the activity of a usage manger when an update is required. At 752, an update is requested. The usage manager determines which reference objects that were previously valid are now invalid by determining whether there is a next reference object (“Ref. Obj.”) at 754, and, if there is, flow 750 moves to 756 to determine whether there is an associated reference object that is invalid or no longer enabled. If invalid or no longer enabled, flow moves to 768 at which a number of reference objects dependent on a memory is determined, and at 762, the memory is deallocated. Flow 750 then moves to 760 to consolidate memory by, for example, copying memory contents from one bank to a next bank at 764 (where possible) so as to minimize the number and size of active memory banks. Flow 750 also determines at 766 whether a memory block is to remain active. If not, unused memory banks are deactivated at 768, the update completed at 770.

Next, optimization of sensor data acquisition is discussed. Consider the process of acquiring data to supply to a sensor data processor, via, for instance, an analog-to-digital converter either on the sensor or sensor data processor, or by using a digital sampling method. In this situation, different data sampling rates may influence power consumption. Typically, the power consumption of the sensor and data acquisition part of the sensor data processor increases with sampling rate, typically in an approximately linear fashion. This is because there is usually a fixed amount of effort and energy required to acquire each sample. Typically, a more reliable inference as to the characteristics of a system or event can be drawn from a higher sample rate, but only to the extent that a signal contains useful information that an algorithm can take advantage of at the higher frequencies represented by the higher sample rate. The power consumption of the data processing operations usually also increase with increasing sample rate, both because more samples need processing, and because filter lengths and the like usually increase.

Consider also the effect of bit-depth on power consumption. In some systems, particularly those that operate at more optimal levels, the higher the bit-depth of data acquisition, the more power is consumed (that is, assuming a system where the bit-depth can be changed). One way to explain this is to consider that oversampling (i.e., increasing the sample rate) is an effective way to increase the bit-depth. Typically, a greater bit-depth can lead to an improvement in the inferences obtained from the data, but only if there is information in the additional bits that an algorithm can take advantage of.

Consider also the effect of buffer size on power consumption. Many sensor systems provide a low-power buffer in which to store data prior to its consumption by the sensor data processor. This enables the sensor data processing element/means to process data in a batch mode, and therefore to operate for a longer period of time at a more efficient operating point. However, the buffering comes at the expense of added latency, which can make the system less responsive to external events and user action.

In general, these three factors (e.g., sampling rate, bit-depth, and buffer size) can be by an algorithm or application developer to the appropriate values, and this can lead to these factors being set higher than optimal in order to ensure that no data is lost, with the result that power consumption is also higher than optimal. Alternatively, if the factors are set too low, then data can be lost and the accuracy of any inferences can be reduced.

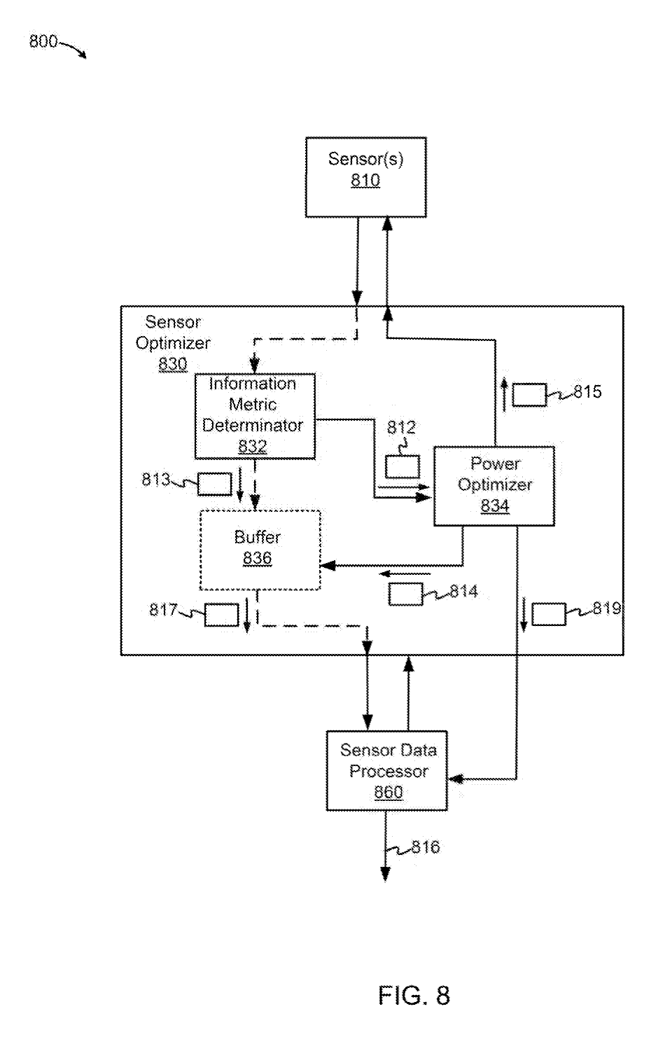

FIG. 8 is a block diagram illustrating a sensor optimizer in accordance with some embodiments. Diagram 800 depicts one or more sensors 810, a sensor optimizer 830 and a sensor data processor 860. Sensor data flows through sensor optimizer 830 as sensor data 813 and sensor data 817. The sensor 810 (or sensors) produces data for processing by sensor data processor 860 possibly via some (optional) intermediate buffer 836. This data is processed by an information metric determinator 834 to produce, for example, a time-varying signal of the amount of useful and/or relevant information in the sensor output data 813. The output data 812 includes information metric data and is transmitted from the information metric determinator 832 to a power optimizer 834 that operates to vary the bit-depth, sample rate and potentially other parameters to maximize the amount of useful information per unit of energy consumed or equivalently to minimize the power consumption per unit of useful information produced.

As noted, information metric determinator 832 receives data from sensor(s) 810, and outputs a time-varying signal 812 (an information-metric signal) that is indicative of the extent to which sensor data 813, 817 contain information that sensor data processor 860 can process in a useful fashion. This metric, discussed below; can be a broad metric or specific to the data-processing being implemented at any time. Information metric determinator 832 can be implemented as part of a sensor data processor 860 or as an alternative signal processing element (e.g. a digital signal processor, a microcontroller or a microprocessor) running software code that implements an information metric algorithm.

Power optimizer 834 can be configured to takes as an input the time-varying information-metric signal 812, and can be configured to generate values or settings 815 for the sensor(s) (and/or control signals to control settings for the sensor(s)), and/or values or control signals for the sensor data processor. Examples of values or settings 815 include buffer sizes, bit depths, and sample rate. Power optimizer 834 can also transmit data 819 representing a sample rate to sensor data processor 860, and power optimizer 834 can control the buffer size 814 of buffer 836. Power optimizer 834 can also take as an input the actual power consumption (or current) for the sensor data processor and/or the sensor(s), and/or it can be configured with an estimate of the power consumption of the system for given configurations of the sensor(s) and sensor data processor. Power optimizer 834 functions to change the sensor settings in order to maximize the information-metric signal while minimizing the power consumption of the system, and in particular to maximize the information-metric signal 812 divided by Power consumption. Power optimizer 834 can be implemented as part of a sensor data processor 860 or as an alternative signal processing element (e.g. a digital signal processor, a microcontroller or a microprocessor) finning software code that implements an information metric algorithm, using suitable optimization algorithm, such as but not limited to, gradient-search, simulated annealing, etc.

As an example, consider a sensor system for which a key processing element requires the separation of input data into a noise component and a signal component for further processing. Note that such sensor systems may have a minimum signal-to-noise ratio (“SNR”) below which they perform poorly but above which they perform relatively well, with a signal-to-noise ratio above the critical threshold value not having a substantially improved effect on the efficacy of the algorithm. For example, for an accelerometer used to measure the tilt of a device or movement of a human limb, as long as the signal (i.e., the acceleration due to gravity) is for example 10 times the noise level (i.e., SNR is 10 dB), the direction of tilt or movement can be determined to within a few degrees, which can be more than sufficient for many applications.

The SNR of such data (comprising noise+signal) where the noise is white can be estimated by the mean of the data divided by the variance of the data, and this SNR can be used as an example of an information-metric. Now consider the case where the SNR is much better than 10 dB. In such an instance, the bit-depth can be reduced (the increased quantization noise will reduce the SNR), or the sample-rate can be reduced (noting that the tilt is nearly a DC signal and therefore a reduction in sample-rate can lead to a reduction in oversampling). If the SNR is worse than 10 dB, then increasing the bit-depth will reduce quantization noise (and hence improve the SNR) while increasing the sample rate will enable oversampling and hence also produce an improvement in SNR.

Note that other information-metrics are possible, with some being generic across a range of sensor data algorithms, and others being more specific to the sensor data algorithms in use. For example, calculating the entropy of the signal, or the Fisher Information metric can be used generically to determine the amount of information in the signal, and such metrics can be used when the particular distribution of the data is poorly known (as such metrics indicate how much information there is, rather than how it is distributed). Another metric might include fitting the data to a range of distributions (e.g. Gaussian, colored noise, band-limited) and then calculating a ratio of how well the data fits one distribution versus another. This technique can be useful when the signal is estimated to follow one distribution, while the noise is estimated to follow another distribution, and hence can indicate the extent to which a useful signal (in excess of the noise) is present.

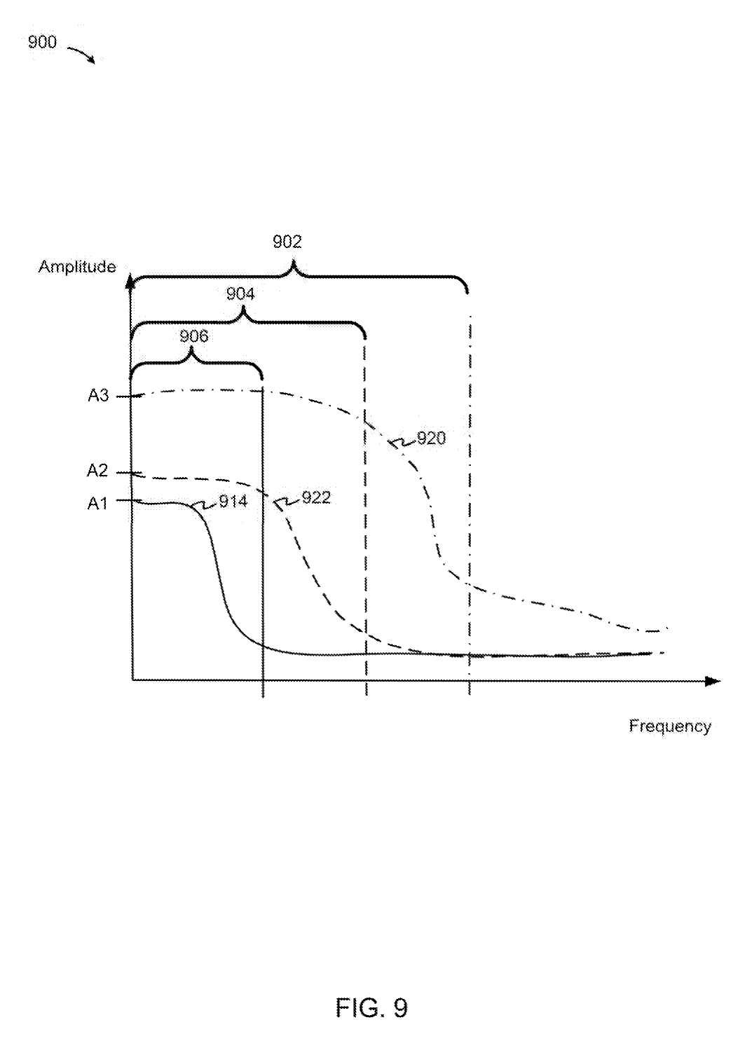

FIG. 9 is a graph illustrating an example of a signal of generated by a sensor, according to one embodiment. In some cases, the sensor, for example, can be an accelerometer attached to a person who might be stationary (0 beats per second), walking slowly (1-2 Hz maybe) or running quickly (maybe 2 Hz). Noise may be limited to vibration in the environment vibration of the human body, and sensor noise. Diagram 900 illustrates three spectra, 914, 920 and 922, one for each of these situations, and for each, the minimum bandwidth (expressed as a frequency range) that would be desired to successfully capture the bulk of the signal information. From the diagram, it can be seen that a suitable metric might be the ratio of energy in the top bands compared to the average band energy. Where the upper bands have a relatively large energy, it is likely that they contain signal information and therefore, the bandwidth should be extended. Where they contain relatively little, the bandwidth (and therefore sample rate) can be reduced. In some examples, the bandwidths for stationary activity has a bandwidth 906, for a walking activity it has a bandwidth 904, and running quickly may have a bandwidth 902.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications can occur to those with ordinary skill in the art.

As used herein, the use of “a,” “an,” or “the” is intended to mean “at least one,” unless specifically indicated to the contrary. In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method to optimize power in wearable or portable devices, the method comprising:
determining a mode of operation of a wearable device in which sensor data is generated by one on or more sensors, the mode of operation associated with data representing processing requirements for a sensor-related operation;
selecting a clock frequency based on an amount of remaining processing cycles of a processor to achieve a target amount of processing cycles performed by the processor for the mode of operation;
allocating an amount of active circuitry in either a first portion of circuitry or a second portion of circuitry as a function of a measure of predicted usage of the data generated by the processor; and
modifying data collection characteristics to determine a subset of data collection characteristics with which the sensor data is consumed by the processor.

2. The method of claim 1, wherein selecting the clock frequency, allocating the amount of active circuitry, and modifying the data collection characteristics reduces power consumption that is otherwise drawn from a battery in the wearable device.

3. The method of claim 1, further comprising:
operating the processor in a switching mode of operation.

4. The method of claim 3, wherein operating the processor in the switching mode of operation further comprises:
operating the processor at a first voltage and at a first clock frequency during a first portion of the sensor-related operation; and
operating the processor at a second voltage and at a second clock frequency during a second portion of the sensor-related operation.

5. The method of claim 3, wherein operating the processor in the switching mode of operation further comprises:
receiving data representing the amount of remaining processing cycles and an amount of time remaining for a timeframe in which the sensor-related operation is performed; and
determining a next clock frequency to establish an efficiency value.

6. The method of claim 5, wherein determining the next clock frequency further comprises:
determining an operating voltage value for the next clock frequency to establish the efficiency value; and
updating the clock frequency with the next clock frequency.

7. The method of claim 1, wherein allocating the amount of active circuitry further comprises:
allocating an amount of memory in either volatile memory or non-volatile of memory as, a function of the measure of predicted usage.

8. The method of claim 7. Wherein allocating the amount of the memory further comprises:
determining a first amount of power to write the data generated by the processor to the non-volatile memory;
determining an amount of time in which the processor is to rewrite the data;
determining a second amount of power to store the data in the volatile memory for the amount of time; and
allocating the amount of memory based on the least power consumed of either the first or the second amounts of power.

9. The method of claim 1, wherein allocating the amount of active circuitry further comprises:
allocating an amount of memory based on whether a reference object associated with the data generated by the processor is similar to other data stored in either volatile memory or non-volatile of memory; and
storing the data in an allocated amount of memory in which the other data shares the same reference object.

10. The method of claim 9, wherein the reference object includes data specifying a relationship in which the sensor-related operation uses the data and the other data.

11. The method of claim 1, wherein allocating the amount of active circuitry further comprises:
allocating an amount of memory comprising:
determining an amount of time in which the data generated by the processor is to be stored; and
storing the data in a first memory bank if the amount of time is equivalent to a first time period, or
storing the data in a second memory bank if the amount of time is equivalent to a second time period, the second time period being greater than the first time period,
wherein data that are stored for longer periods of time are stored in memory banks having smaller sizes than data that are stored for shorter periods of time.

12. The method of claim 1, wherein the data collection characteristics comprises a sampling rate, a bit-depth and/or a buffer size.

13. The method of claim 12, wherein modifying the data collection characteristics comprises:
maximizing an amount of the sensor data retrieved from the one or more sensors per unity of energy consumed.

14. The method of claim 12, wherein modifying the data collection characteristics comprises:
determining data representing an information metric.

15. The method of claim 14, wherein the information metric includes data representing a value of the sampling rate, a value of the bit-depth and a size of the buffer configured to provide an optimal value of power efficiency for the wearable device.

16. A wearable device comprising:
one or more sensors; and
a sensor data power optimization controller configured to optimize a measure of energy efficiency indicative of the power consumed by one or more circuits activated per unit of processing, the sensor data power optimization controller comprising:
a power-clock controller configured to select a clock frequency based on an amount of remaining processing cycles of a processor to achieve a target amount of processing cycles performed by the processor and an amount of time remaining for a timeframe in which the processor performs a sensor-related operation;
a memory optimizer configured to allocate an amount of memory in either volatile memory or non-volatile of memory based on the least power consumed of using either the volatile memory or the non-volatile of memory; and
a sensor optimizer configured to determine a subset of data collection characteristics with which the sensor data is retrieved for used by the processor.

17. The wearable device of claim 16, wherein power-clock controller comprises:
a clock rate controller configured to generate an updated clock frequency for the clock frequency based on the amount of remaining processing cycles and an amount of time remaining for a timeframe;
a multi-rate clock generator configured to generate the updated clock frequency; and
a variable power supply configured to generate a voltage level in which the voltage level and the updated clock frequency provides an optimal value of efficiency.

18. The wearable device of claim 16, wherein the memory optimizer comprises:
an allocator configured to allocate the memory as a function of a measure of predicted usage of the data generated by the processor, and further configured to allocate the memory based on whether a reference object associated with the data generated by the processor is similar to other data stored in either the volatile memory or the non-volatile of memory; and
a usage manager configured to enable memory banks and deallocate the memory based on the invalidity of the reference object.

19. The wearable device of claim 16, wherein the sensor optimizer comprises:
an information metric determinator configured to determine information metric data representing a value of the sampling rate, a value of the hit-depth and size of a buffer configured to provide an optimal value of power efficiency for the wearable device.

20. The wearable device of claim 16, wherein the processor comprises:
a sensor data processor.
